(19) United States
(12) Patent Application Publication
(10) Pub. No.: US 2018/0060458 A1
(43) Pub. Date: Mar. 1, 2018

(54) USING THE INFORMATION OF A DEPENDENT VARIABLE TO IMPROVE THE PERFORMANCE IN LEARNING THE RELATIONSHIP BETWEEN THE DEPENDENT VARIABLE AND INDEPENDENT VARIABLES

(71) Applicant: Futurewei Technologies, Inc., Plano, TX (US)

(72) Inventors: Wenwen Zhao, Davis, CA (US); Ying Li, Hillsborough, NJ (US); Baoling Sheen, Kildeer, IL (US); Jin Yang, Bridgewater, NJ (US)

(73) Assignee: Futurewei Technologies, Inc., Plano, TX (US)

(21) Appl. No.: 15/251,201

(22) Filed: Aug. 30, 2016

(51) Int. Cl. G06F 17/50; H04W 16/22; G06N 99/00

(52) U.S. Cl. CPC G06F 17/509; G06N 99/005; H04W 16/22

(57) ABSTRACT

A device comprises a non-transitory memory having instructions and one or more processors in communication with the memory. The one or more processors execute the instructions to receive training data that represent dependent variable information from a plurality of cells in a cellular network. One or more clusters of cells are selected from the plurality of cells; while, one or more sub-clusters of cells are selected from the one or more clusters based on the dependent variable information. One or more models are determined corresponding to the one or more sub-clusters of cells based on the relationship between dependent variable information and independent variable information. A prediction value is output from the one or more models in response to the received testing data.

### BACKGROUND

In many areas of science, finance, and industry, learning the relationship between a vector of independent variables (IVs) X^{T}=(X₁, X₂ . . . X_{P}) and a dependent variable (DV) Y may be important. For example, in wireless communications, a DV may be a key quality indicator (KQI) in a cellular network such as packet loss, delay, etc. in each cell, while IVs may include key performance indicators (KPIs) such as handover success rate, physical channel resource usage rate, interference level, etc. in the cell. In some cases, a DV may be a particular KPI, such as mobile user average throughput, cell total throughput, etc., while the IVs may include the number of active users in the cell, number of bits served in the cell, etc.

Improving the learning of the relationship (or mapping) between the IVs and a DV may enable accurately predicting the behavior of a particular wireless communication system or network (for example, predicting KQIs or KPIs of a system or portion thereof). When predicted KQIs or KPIs do not meet system requirements, optimization of the network, or expansion of the network may be contemplated and/or realized.

### SUMMARY

A device comprises a non-transitory memory having instructions and one or more processors in communication with the memory. The one or more processors execute the instructions to receive training data that represent dependent variable information from a plurality of cells in a cellular network. One or more clusters are selected from the plurality of cells; while, one or more sub-clusters of cells are selected from the one or more clusters based on the dependent variable information. One or more models corresponding to the one or more sub-clusters are determined based on the relationship between dependent variable information and independent variable. A prediction value is output from the one or more models in response to the received testing data.

In another embodiment, the present technology relates to a computer-implemented method. The steps include receiving training data that represent dependent variable information from a plurality of cells in a cellular network. One or more clusters are selected from the plurality of cells; while, one or more sub-clusters of cells are selected from the one or more clusters based on the dependent variable information. One or more models corresponding to the one or more sub-clusters are determined based on the relationship between dependent variable information and independent variable. A prediction value is output from the one or more models in response to the received testing data.

In another embodiment, a device comprises a non-transitory memory having instructions and one or more processors in communication with the memory. The one or more processors execute the instructions to receive training data that represent dependent variable information from a plurality of cells in a cellular network. One or more clusters of cells are selected from the plurality of cells. One or more models are determined based on the relationship between dependent variable information and independent variable information. Testing data from the plurality of cells in the cellular network is received. A first model is selected from the one or more models based on the dependent variable information. A prediction value is output to analyze the cellular network from the first model in response to the testing data.

In another embodiment, the present technology relates to a computer-implemented method. The steps include receiving, with one or more processors, training data that represent dependent variable information from a plurality of cells in a cellular network. One or more clusters of cells are selected from the plurality of cells One or more models are determined based on the relationship between dependent variable information and independent variable information. Testing data from the plurality of cells in the cellular network is received. A first model is selected from the one or more models based on the dependent variable information. A prediction value is output to analyze the cellular network from the first model in response to the testing data.

This Summary is provided to introduce a selection of concepts in a simplified form that are further described below in the Detailed Description. This Summary and/or headings are not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a flowchart that illustrates a method to use DV information in selecting sub-clusters according to embodiments of the present technology.

FIG. 2 is a flowchart that illustrates a method to use DV information to select a model according to embodiments of the present technology.

FIG. 3 is a flowchart that illustrates a method that uses DV information in selecting sub-clusters and a model according to embodiments of the present technology.

FIG. 4 is a table that illustrates a comparison of results using a method illustrated in FIG. 1 according to embodiments of the present technology.

FIG. 5 is a table that illustrates a comparison of results using a method illustrated in FIG. 2 according to embodiments of the present technology.

FIG. 6 is a table that illustrates a comparison of results using a method illustrated in FIG. 3 according to embodiments of the present technology.

FIG. 7 is a table that illustrates a comparison of results of methods as candidates in an ensemble according to embodiments of the present technology.

FIG. 8 is a table that illustrates a comparison of results of methods as candidates in an ensemble according to embodiments of the present technology.

FIG. 9 is a block diagram that illustrates a hardware architecture to use DV information according to embodiments of the present technology.

FIG. 10 is a block diagram that illustrates a software architecture to use DV information according to embodiments of the present technology.

FIG. 11 illustrates a wireless communication network according to embodiments of the present technology.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The present technology generally relates to improving the learning of the relationship between IVs and a DV. DV information may be used to improve the performance in learning of the relationship between IVs and the DV. DV information may include one or more DV values or information that represents, or partially represents, a DV such as a DV's range or band. In an embodiment, after clustering or grouping data according to some criterion, a DV's range or band may be used to select sub-clusters, which yields a finer cluster and a clearer relationship. In another embodiment, DV information is used to aid the testing data to select a best fitted model from all models learned in the clusters. In an embodiment, using DV information to select sub-clusters and select a best fitted model are combined that may further improve learning the relationship between IVs and the DV. Dependent information may be used in selecting candidate methods for an ensemble, which may provide better performance in learning the relationship between IVs and the DV.

It is understood that the present technology may be embodied in many different forms and should not be construed as being limited to the embodiments set forth herein. Rather, these embodiments are provided so that this disclosure will be thoroughly and completely understood. Indeed, the disclosure is intended to cover alternatives, modifications and equivalents of these embodiments, which are included within the scope and spirit of the disclosure as defined by the appended claims. Furthermore, in the following detailed description, numerous specific details are set forth in order to provide a thorough understanding of the technology. However, it will be clear that the technology may be practiced without such specific details.

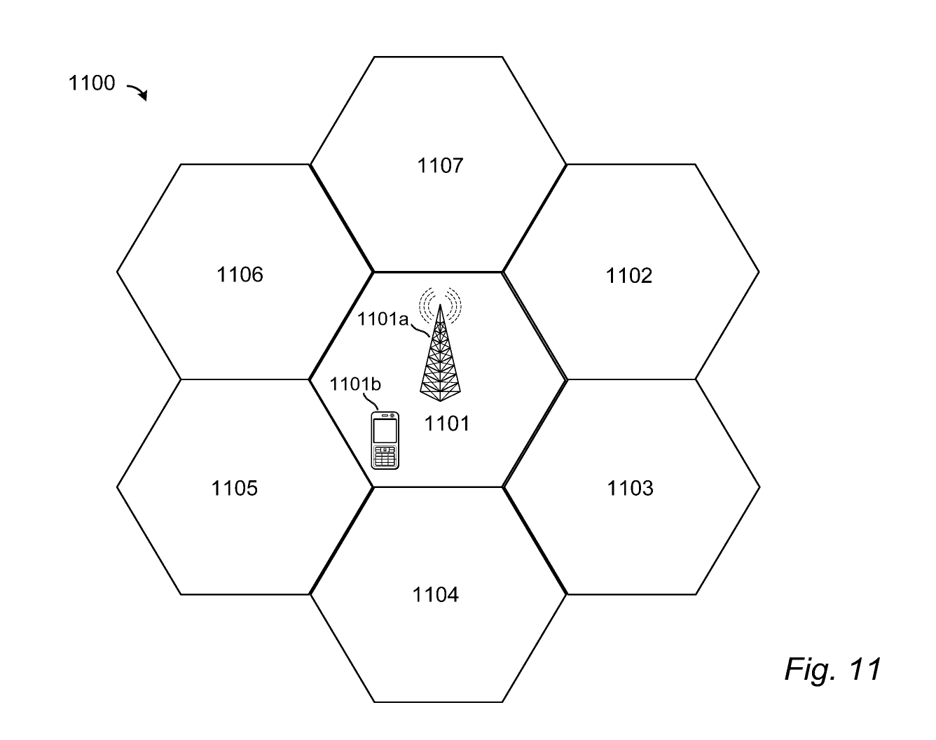

In a wireless communication embodiment as illustrated in FIG. 11 and described herein, a DV may be a time series, for example, the average throughput of a particular cell in a cellular network, where the average throughput can be for a period of time, e.g., each 15 minutes, 30 minutes, or 1 hour, etc. An IV (e.g., the average number of active user in a cell) in the IVs may also be a time series, which may have the same time interval (or a different time interval) for the sampled values or observations in embodiments. A DV or IV may be from one or multiple cells in a network, or in a region, an area, etc. In another embodiment, each cell may have its observations or sampled values for the DV or IVs.

In embodiments, a DV may be a key quality indicator (KQI) such as packet loss or delay, etc., and IVs may include key performance indicators (KPIs) such as total traffic amount in one or more cells, total number of bits transmitted in one or more cells, total number of users in in one or more cells, uplink interference level, handover success rate or physical channel resource usage rate, etc. In embodiments, a DV may be a particular KPI, such as mobile user average throughput in a cell or cell level total throughput, etc. and the IVs may include a number of active users in the cell or number of bits served in the cell, etc. In an embodiment, a KPI may include but is not limited to a mobile user's average throughput, total (data) throughput, call drop rate, data connection packet loss, data connection latency, voice connection jitter rate, call set-up time and handover success rate.

In an embodiment having a plurality of cells, all the observations in time of all the cells for the IVs and a DV may be used, in the data analytics and learning for determining the relationship between the IVs and the DV, or in other word, finding a mapping from the IVs to the DV. This may be referred to as global learning in an embodiment, as it uses the observations from all the cells.

In embodiments, not all the cells would have similar relationships between the IVs and a DV. Some cells (e.g., cells in an urban area or hot zone) may have a different relationship between the IVs (e.g., number of active UEs, number of bits, etc.) and the DV (e.g., average cell throughput) as compared to cells in suburban area. The wireless channels for the cells in an urban area or hot zone (due to high rise buildings, etc.) may be different from those for the cells in suburban area. Hence, in some embodiments, it may be beneficial to learn the relationship between the IVs and a DV at a cluster level, where each cluster represents a group or a subset of the cells (if not all), and each cluster of the cells may have a relationship between the IVs and a DV.

In an embodiment, the finest granularity of the learning of the relationship between the IVs and a DV may be at a cell level. However, the number of observations or sample values that each cell may be significantly smaller as compared to the number of the sample values that a cluster or a global level of learning may have. The smaller number of observations at the cell level may reduce the accuracy of a learned relationship between the IVs and a DV at the cell level as compared to the cluster level. In embodiments, the cluster level of the learning may provide a good tradeoff in terms of the accuracy of the relationship between the IVs and a DV, and the size of the data or observations.

At the cluster level of learning of the relationship between IVs and a DV, the cells in a same cluster may have similar or the same relationship between the IVs and the DV. A mapping function may be determined from the IVs to the DV for each cluster, so that the mapping may be used to predict the DV when the IVs are available as the inputs (e.g., the IVs or IV information may be (or represent) some of the independent variable values available, or may be of values predicted by using other variables which may be known or obtained). In an embodiment, one of the important steps is to do the clustering (i.e., forming the cell groups, where each group of the cells form a cluster) so that the cells in a same cluster can have the similar or same relationship between IVs and a DV. In an embodiment, cells may be clustered by using a subset of IVs and a DV to get a global level (using all the cells) of the relationship, and then use the residual error information (the actual value of the observation against the prediction value using the global relationship) to group the cells with similar residual error. In an embodiment, the cells with a similar relationship between the IVs and a DV may be put in the same cluster.

To cluster the cells with a similar or same relationship between the IVs and a DV in the same cluster may be very important for the overall performance of the learning of the relationship between the IVs and a DV in an embodiment. The performance of the learning of the relationship between the IVs and a DV may be improved by using DV information. As described in detail herein, learning of the relationship between the IVs and a DV may be improved by using DV information to form sub-clusters from clusters as well as aid the testing data in selecting a best fitted model from all the models learned in the clusters.

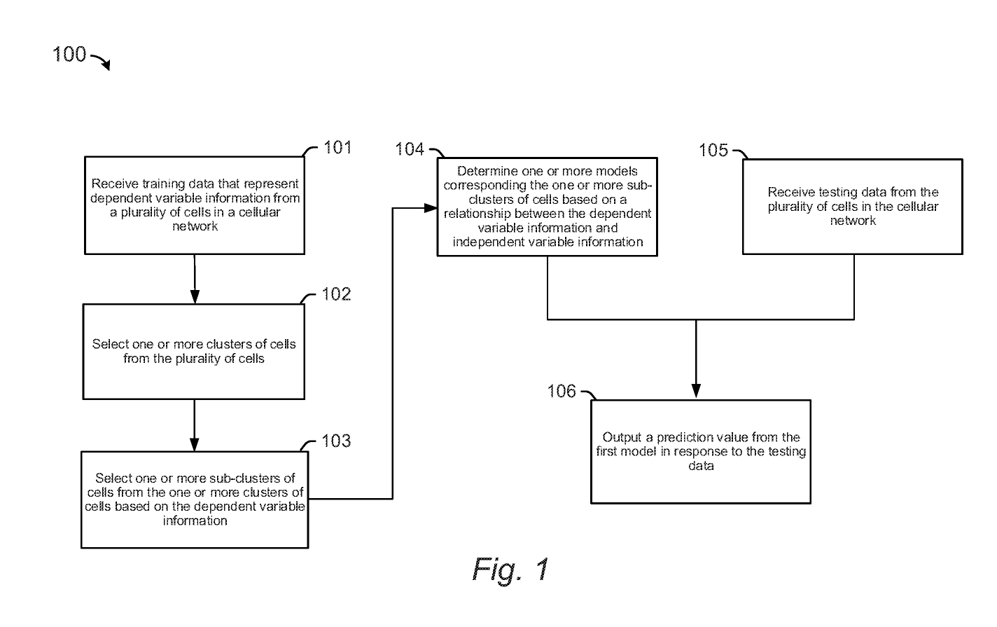

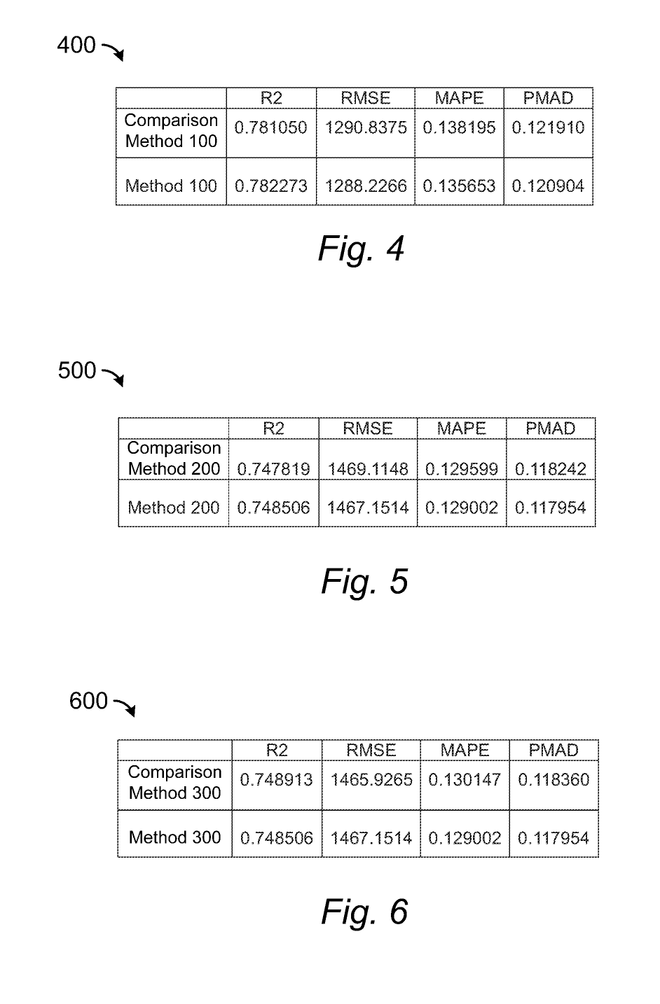

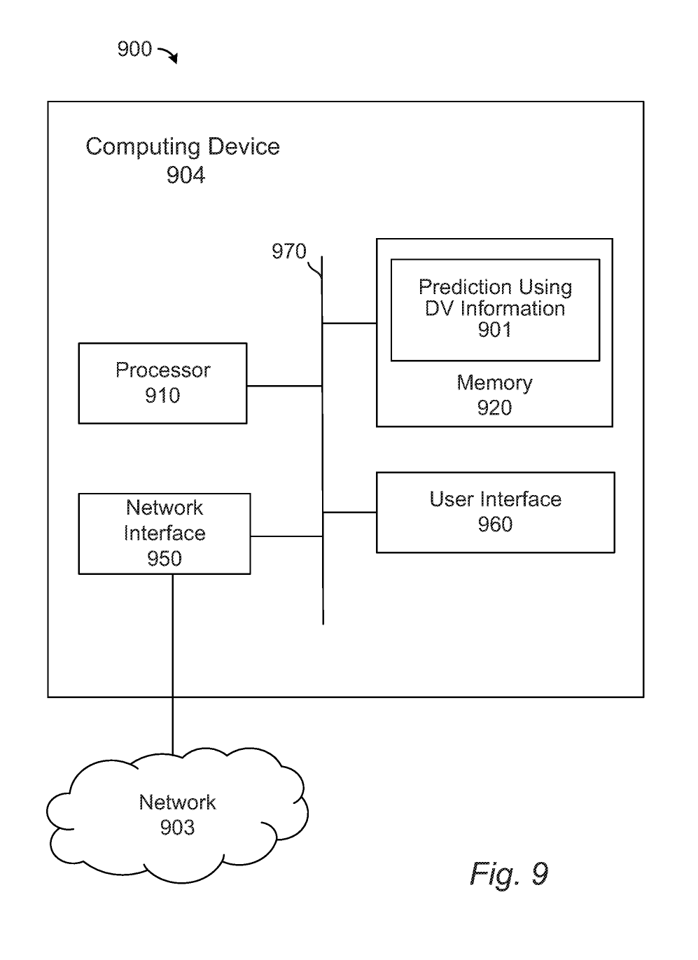

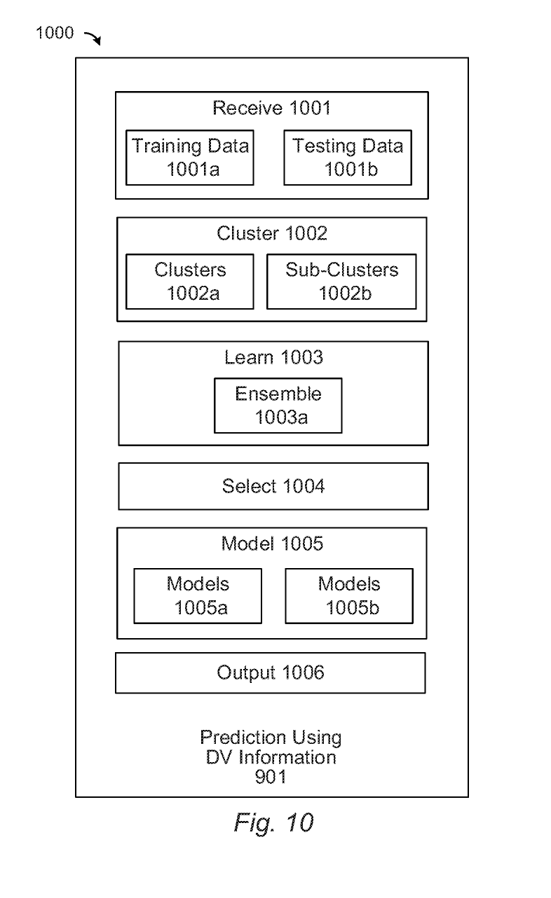

FIGS. 1-3 are flowcharts that illustrate methods to use DV information to improve the learning of the relationship between IVs and a DV in wireless communication, such as a cellular network, according to embodiments of the present technology. In embodiments, flowcharts in FIGS. 1-3 are computer-implemented methods performed, at least partly, by hardware and software components illustrated in FIGS. 9 and 10 and as described below. In an embodiment, software components in FIG. 10, executed by one or more processors, such as processor 910 shown in FIG. 9, perform at least a portion of the methods. FIGS. 4-8 are tables illustrating improvements in the learning of the relationship between IVs and a DV when using DV information as described herein.

FIG. 1 is a flowchart that illustrates a method 100 to use DV information in selecting sub-clusters from some or all clusters of cells in a cellular network according to embodiments of the present technology.

At 101 and 105 training and testing data is received according to embodiments of the present technology. In an embodiment, receive 1001 shown in FIG. 10 executed by processor 910 shown in FIG. 9 performs at least a portion of these functions. In embodiments, training data is stored an electronic file in training data 1001a and testing data is stored as an electronic file in testing data 1001b as illustrated in FIG. 10.

In an embodiment, training data and testing data are split from a dataset of observed or measured (sampled) values from a cellular network. In an embodiment, training data is a first time series and testing data is a second time series. In an embodiment, training data is a first set of measured values from a cellular network (or portion thereof) during a first interval of time, such a first portion of a month, and the testing data is a second set of measured values from the cellular network (or portion thereof) during a second interval of time, such as a second portion of the month.

At 102 one or more clusters of cells in the cellular network are determined by applying some criterion to training data. It is noted that the process to determine one or more clusters of cells from a plurality of cells can be referred to as clustering, cell clustering, or clustering the cells. It can be also referred to as selecting one or more clusters of cells from a plurality of cells. In embodiments, the criterion for clustering may be a k-medoid clustering method such as a Partitioning Around Medoids (PAM) method. In an embodiment, cluster 1002 as seen in FIG. 10 executed by processor 910 performs at least a portion of this function. In an embodiment, cluster 1002 accesses training data 1001a to determine and store K clusters 1002a.

At 103 DV information is used to determine one or more sub-clusters from the one or more clusters determined at 102. In an embodiment, DV information may be: a band or bands of a DV value, a range of a DV value, a most common DV value or any other information extracted from the DV values, singly or in combination. In an embodiment, sub-clustering at 103 may be the same or a different type of clustering than is used at 102. Using a different type of sub-clustering at 103 than at 102 may result in better performance. In an embodiment, a PAM method or other type of clustering method may be used to perform the sub-clustering at 103. In an embodiment, cluster 1002 executed by processor 910 performs at least a portion of this function. In an embodiment, cluster 1002 accesses training data 1001a to select one or more sub-clusters 1002b. In embodiments, a cluster and/or sub-cluster is selected group of cells in a cellular network.

At 104 a learning method is applied to the training data associated with the respective one or more sub-clusters to learn the relationships between the IVs and a DV for each of the one or more sub-clusters. Once the relationship between the IVs and a DV for each of the one or more sub-clusters is learned, one or more models associated with the one or more sub-clusters are determined. In an embodiment, learn 1003 executed by processor 910 performs at least a portion of this function. In an embodiment, learn 1003 accesses training data 1001a associated with one or more sub-clusters to provide respective one or more models 1005a stored in model 1005. In embodiments, learn 1003 may be a machine learner that determines the relationship between two sets of data, such as between IV information and DV information.

At 105 testing data is provided to one or more models corresponding with the one or more sub-clusters at 104 to output a prediction at 106 or at least one prediction value from at least a first model. In embodiments, a prediction may be obtained for each of the one or more sub-clusters. In an embodiment, select 1004, model 1005 and output 1006 executed by processor 910 performs at least a portion of this function. In an embodiment, select 1004 selects the appropriate set of testing data for each of the one or more sub-clusters. One or moremodels associated with the one or more sub-clusters provides a prediction value to output 1006 in response to inputting the appropriate set of testing data. Output 1006 then outputs the at least one prediction value to a user interface in an embodiment.

Method 100 may have wide potential usage, as the relationship of IVs and a DV for each cell in one cluster may be most probably similar but not the same, and some of them may even have different patterns that cannot be detected in a first level of clustering. Hence in an embodiment, by further using the DV information, finer groups or sub-clusters may make the relationships of cells in each sub-cluster more similar.

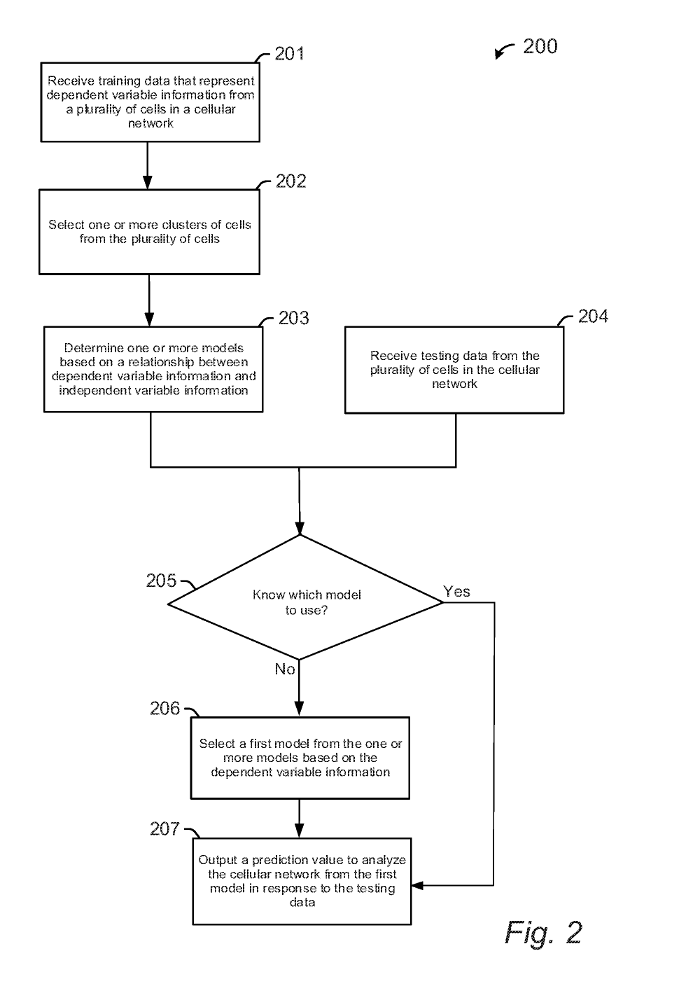

FIG. 2 is a flowchart that illustrates a method 200 that uses DV information to aid each of the testing data select a best fitted model from one or more clusters of cells in a cellular network according to embodiments of the present technology.

At 201 and 204 training data and testing is received according to embodiments of the present technology. In an embodiment, receive 1001 shown in FIG. 10 executed by processor 910 shown in FIG. 9 performs at least a portion of these functions. In embodiments, training data is stored as in an electronic file in training data 1001a and testing data is stored in an electronic file in testing data 1001b as illustrated in FIG. 10.

Similar to method 100, training data and testing data may be split from a dataset of observed or measured values from a cellular network in an embodiment.

At 202 one or more clusters of cells in the cellular network are selected by applying some criterion to training data. In embodiments, the criterion for clustering may be a PAM method. In an embodiment, cluster 1002 executed by processor 910 performs at least a portion of this function. It is noted that at 202, it may use the clustering method described as in 102 and 103, or it may use clustering method other than the one described as in 102 and 103.

At 203 a learning method is applied to the training data associated with the respective one or more clusters to learn the relationships between the IVs and a DV for each of the one or more clusters. Once the relationship between the IVs and a DV for each of the one or more clusters is learned, one or more models associated with the one or more clusters are determined. In an embodiment, learn 1003 executed by processor 910 performs at least a portion of this function. In an embodiment, learn 1003 accesses training data 1001a associated with one or more clusters to provide respective models 1005b stored in model 1005. In embodiments, learn 1003 may be a machine learner that determines the relationship between two sets of data, such as between IV information and DV information. It is noted that at 203, it may be the models 104 for the clusters or subclustering resulted from clustering 102 and subclustering 103, or it may be the models for the clusters resulted from clustering or subclustering other than 102 and 103.

At 205 a determination is made as to which model in the one or more models to use for a particular set of testing data associated with a cluster in the one or more clusters. When it is known which model in the one or more models to use, the known model is used to provide a prediction at 207 (or prediction value) in response to the set of testing data associated with the cluster.

At 205 when it is not known which model in the one or more models to use for a particular set of testing data associated with a cluster in the one or more clusters, DV information or a combination of DV information and other criteria may be used to determine the appropriate model of the one or more models (or best fitted model) at 206. The best fitted model of the one or more models then outputs a prediction at 207 (or prediction value) from at least a first model. In an embodiment, select 1004, model 1005 and output 1006 executed by processor 910 performs at least a portion of this function. In an embodiment, select 1004 selects the appropriate set of testing data for each of the one or more clusters. Select 1004 also selects the known model for each of the one or more clusters in models 1005a. Each of the known models associated with the one or more clusters provides a prediction value to output 1006 in response to inputting the appropriate set of testing data. Output 1006 then outputs the at least one prediction value to a user interface in an embodiment.

Methods for using DV information to select a model at 206 may include:

1) Compare a DV's band of the testing data and of the clusters in the one or more clusters, and then determine the cluster(s) that the testing data's DV's band matches. When there are multiple clusters determined in one or more clusters, other criteria may be used to select among these clusters.

2) Calculate a similarity/difference metric between the test data and all clusters in the one or more clusters using DV information. Then use the similarity/difference metric alone or along with other criteria (such as a weighted sum of them) to select the model from the one or more models for the appropriate test data.

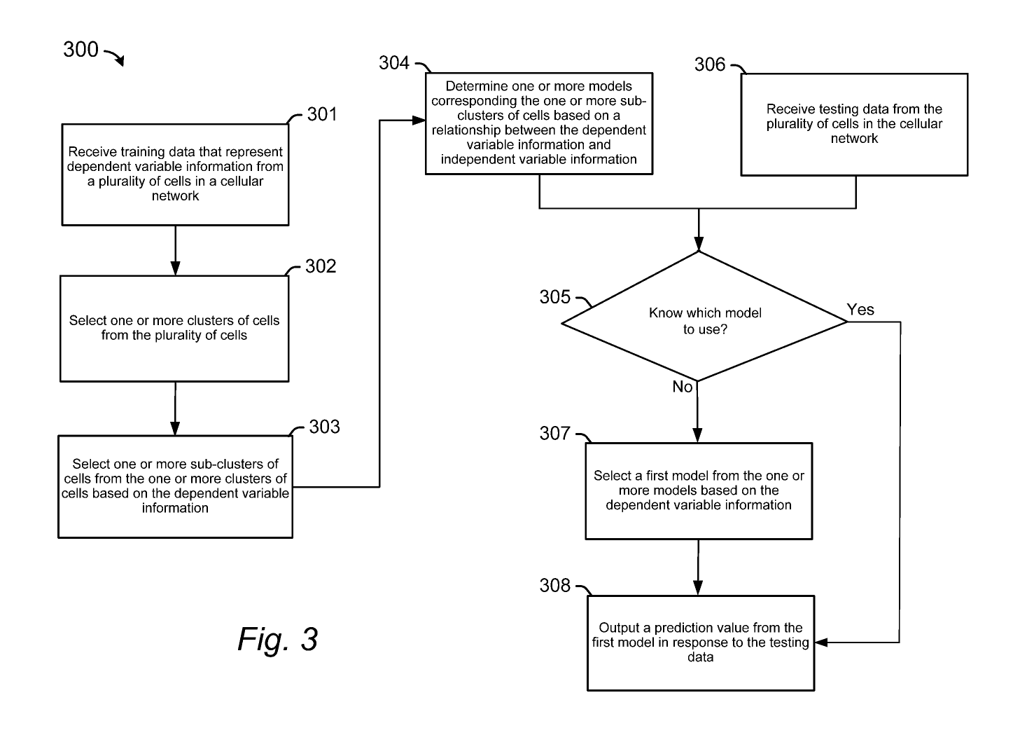

FIG. 3 is a flowchart that illustrates a method 300 to use DV information in selecting sub-clusters and aid each of the testing data to select a best fitted model according to embodiments of the present technology. In an embodiment, method 300 is a combination of method 100 and 200. In particular, method 300 uses DV information to sub-cluster the data from some or all clusters to select one or more sub-clusters and then use DV information to aid each of the testing data to select the best fitted model.

At 301 and 306 training and testing data is received according to embodiments of the present technology. In an embodiment, receive 1001 shown in FIG. 10 executed by processor 910 shown in FIG. 9 performs at least a portion of these functions. In embodiments, training data is stored as an electronic file in training data 1001a and testing data is stored as an electronic file in testing data 1001b as illustrated in FIG. 10.

In an embodiment, training data and testing data are split from a dataset of observed or measured values from a cellular network as described herein.

At 302 one or more clusters of cells in the cellular network are selected by applying some criterion to training data. In embodiments, the criterion for clustering may be a PAM method. In an embodiment, cluster 1002 executed by processor 910 performs at least a portion of this function. In an embodiment, cluster 1002 accesses training data 1001a to select and store one or more clusters 1002a.

At 303 DV information is used to select one or more sub-clusters one or more clusters determined at 302. In an embodiment, DV information may be: a band or bands of a DV value, a range of a DV value, a most common DV value or any other information extracted from DV values, singly or in combination. In an embodiment, sub-clustering at 303 may be the same or a different clustering method that is used at 302. In an embodiment, a PAM method or other type of clustering method may be used to perform the sub-clustering at 303. In an embodiment, cluster 1002 executed by processor 910 performs at least a portion of this function. In an embodiment, cluster 1002 accesses training data 1001a to determine one or more sub-clusters 1002b. In embodiments, a cluster and/or sub-cluster is selected group of cells in a cellular network.

At 304 a learning method is applied to the training data associated with the respective one or more sub-clusters to learn or determine the relationships between the IVs and a DV for each of the one or more sub-clusters. Once the relationship between the IVs and a DV for each of the one or more sub-clusters is learned, one or more models associated with the one or more sub-clusters are determined. In an embodiment, learn 1003 executed by processor 910 performs at least a portion of this function. In an embodiment, learn 1003 accesses training data 1001a associated with one or more sub-clusters to provide respective models 1005a stored in model 1005. In embodiments, learn 1003 may be a machine learner that determines the relationship between two sets of data, such as between IV information and DV information.

At 305 a determination is made as to which model in the one or more models to use for a particular set of testing data associated with a cluster in the one or more clusters. When it is known which model in the one or more models to use, the known model is used to provide a prediction at 308 (or prediction value) in response to the set of testing data associated with the cluster.

At 305 when it is not known which model in the one or more models to use for a particular set of testing data associated with a cluster in the one or more clusters, DV information or a combination of DV information and other criteria may be used to determine the appropriate model of the one or more models (or best fitted model) at 307. The best fitted model of the one or more models then outputs a prediction at 308 (or prediction value) from at least a first model. In an embodiment, select 1004, model 1005 and output 1006 executed by processor 910 performs at least a portion of this function. In an embodiment, select 1004 selects the appropriate set of testing data for each of the one or more clusters. Select 1004 also selects the known model for each of the one or more clusters in models 1005a. Each of the known models associated with the one or more clusters provides a prediction value to output 1006 in response to inputting the appropriate set of testing data. Output 1006 then outputs the at least one prediction value to a user interface in an embodiment.

Methods for using DV information to select a first model at 307 may include at least methods described in method 200.

Comparisons of the methods' performances in a cellular network embodiment are described below. In other embodiments, less or better performance may be achieved. In the cellular network, similar to cellular network 1100 shown in FIG. 11, data is gathered from 771 cells in 56 days over 4 months. Each IV or DV is a time series, and the observations are per hour for data. After selecting the busy hours, there are 645,989 observations in total.

In a cellular network embodiment, IVs for a cell are the number of downlink active users in the cell, the total bits (traffic) of the downlink of the cell, and the total bits (traffic) of the uplink of the cell. A DV is the average throughput of the downlink. In the cellular network embodiment, a DV (or average throughput of the downlink) of a particular cell is predicted using IVs of the particular cell (the number of downlink active users, total traffic of the downlink, and total traffic of the uplink). In an embodiment, cell physical features like antenna height, azimuth and etc. may be used in the prediction.

Among the 56 days used to gather data, 13 days in the latest two months are selected as future time, and the remaining 43 days are chosen as previous time.

For method 100, observations of all cells in future time are chosen as testing data, and other cells are chosen as training data.

For method 200, about 80% of the cells are selected as training cells and the remaining 20% of cells are used as testing cells. Observations of training cells in previous time are used to train the models. Then observations of testing cells in previous time are used as validation data to select the best fitted model. Observations of testing cells in future time are used for the prediction (predicting average throughput of the downlink).

In a first example using method 100, each of the test data knows the group it belongs to. In a clustering step (102 in FIG. 1), method 100 first uses all the training data to train a regression model (using generalized additive model (GAM) method), then calculates the training error information. Method 100 uses the training error information as parameters to cluster the train data into 21 clusters. DV information (or a DV value band) (103 in FIG. 1) is used to further sub-cluster the data in some selected clusters to obtain 39 groups in total. The data in each group is trained and a finer model applied to the testing data.

FIG. 4 illustrates a table 400 comparing test results using method 100 with and without sub-clustering. Table 400 compares the testing results of 39 groups using sub-clustering (method 100) and 39 clusters without using sub-clustering (or without using 103 in method 100). “Comparison Method 100” in Table 400 is used to denote the method 100 without sub-clustering using DV information (103 in method 100).

Tables 400-800 provide values indicating how close test data is to a prediction value (or DV value, such as average throughput of the downlink of a cell). Tables 400-800 illustrates R2, RMSE, MAPE and PMAD values in columns.

R2 (R-squared or R²) is a statistical measure of how close the data is to fitted regression line. It is also known as the coefficient of determination, or the coefficient of multiple determination for multiple regression.

RMSE (root mean squared error) is a statistical measure of the difference between data that are known and data that have been interpolated or digitized. RMSE is the square root of the variance, known as the standard deviation in an embodiment.

MAPE (mean absolute percentage error, a.k.a. mean absolute percentage deviation (MAPD)) is a statistical measure of prediction accuracy of a forecasting method. In an embodiment, MAPE expresses accuracy as a percentage.

PMAD (Percent Mean Absolute Deviation) is a statistical measure for forecast accuracy.

As seen in Table 400, about 2% improvement in MAPE and 1% improvement in PMAD is observed when method 100 is applied.

In a second example, each of the testing cells has to select the group it belongs to. Similarly with the first example, a DV value band is combined with some IV bands and cell physics are used for sub-clustering after clustering using the training error information.

After learning a model for each group, a best fitted model is selected for each of the testing cells. In an embodiment, a first criterion (denoted as “criterion 1”) to select the best fitted model includes applying all models to the validation data (observations of testing cells in previous time) to obtain the training error information. The best fitted model is then selected according to the training error information (e.g. a model with least PMAD). In method 200, a weighted sum of the criterion 1 and the “similarity metric” of the features used in sub-clustering between the training data and the validation data is used to select the best fitted model, shown below as “new criterion.”

new criterion=w₁*similarity metric+w₂*criterion 1

FIG. 5 illustrates a Table 500 including results comparisons using method 200 or a similar method.

“Comparison Method 200” in Table 500 of FIG. 5 denotes values indicating prediction accuracy of a method that uses the same sub-clustering method as used in example 1 and uses criterion 1 to choose the best fitted model. “Method 200” in Table 500 denotes values indicating prediction accuracy of a method 200 that uses the new criterion to select the best fitted model.

As seen in Table 500, about 0.5% improvement in MAPE and 0.2% improvement in PMAD is observed when using DV information in a method similar to method 200.

In a third example, a combination of methods 100 and 200 are used. Similar to the second example, DV information is used for sub-clustering and selecting a best fitted model for the test cells. In the comparison method (denoted as “Comparison Method 300”), a clustering step is used (no sub-clustering) and criterion 1 is used to select the best fitted model for the testing cells.

As seen in Table 600 of FIG. 6, about 1% improvement in MAPE and 0.4% improvement in PMAD is observed when using DV information in a method 300 or a similar method.

In an embodiment, methods, such as methods 100, 200 and 300, may be used as candidates for an ensemble or an ensemble method. In an embodiment, an ensemble may use multiple computer-implemented methods to obtain a better predictive result than a single method. In an embodiment, an ensemble or ensemble method is a supervised learning (or learner, machine learner) method that is trained to build a model used to make predictions in response to inputs.

In an embodiment, ensemble 1003a in FIG. 10, executed by one or more processors, such as processor 910 shown in FIG. 9, performs at least a portion of an ensemble method as described herein.

In an ensemble method (or a “true ensemble”), testing data may be split into two parts. After using training data (such as training data 1001a) to obtain a model for each candidate method (such as methods 100, 200 and 300), a first part of testing data (such as a first part of testing data 1001b) is used as validation data to obtain an estimation of the performance of each model for each of candidate method. In an embodiment, a particular criterion may be used to select which candidate method to use for each of the testing data. In an alternate embodiment, a rule may be designed to combine prediction results (or values) from all the candidate methods for each of the testing data. In a “true ensemble” embodiment, a second part of the testing data is used to obtain prediction results. In an alternate “potential ensemble” embodiment, testing data is used as both validation data and testing data to obtain a rough upper bound of the ensemble results due to data size limitations.

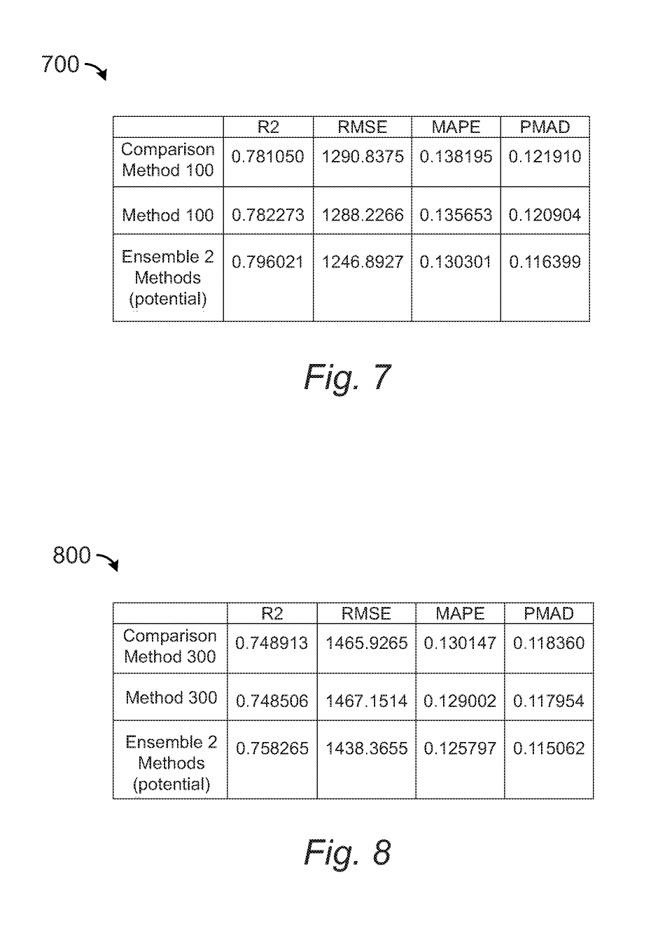

In Tables 700-800 shown in FIGS. 7-8, “(”potential“)” indicates the results are from a potential ensemble using testing data for both validation data and testing data to obtain prediction results as described above to differentiate from a true ensemble. Tables 700 and 800 are similar to Tables 400 and 600 with an additional row to indicate results when the respective methods in the previous tables are ensembled. For example, results labeled “Ensemble 2 methods (potential)” in Table 700 are results from an ensemble (potential) of comparison method 100 and method 100. Similarly, results labeled “Ensemble 2 methods (potential)” in Table 800 are results from an ensemble (potential) of comparison method 300 and method 300. From Table 700, one can see there is about 5.7% potential gain after using an ensemble of the two methods in MAPE and 4.5% potential gain in PMAD. Table 800 shows ensemble results for the third example. From Table 800, one can see that there is about 3.3% potential gain after an ensemble of the two methods in MAPE and 2.8% potential gain in PMAD.

In an embodiment, a first level of clustering (such as at 102 in FIG. 1) may be alternated with a second level of clustering (such as 103 in FIG. 1). For example, the first level clustering may use the DV information, while the second level clustering may use the residual based relationship of a DV and IVs. In another embodiment, two levels of clustering may be replaced with more than two levels of clustering.

FIG. 9 illustrates a hardware architecture 900 for computing device 904 that uses DV information to improve learning of a relationship between IVs and a DV according to embodiments of the present technology. Computing device 904 may include a processor 910, memory 920, a user interface 960 and network interface 950 coupled by a interconnect 970. Interconnect 970 may include a bus for transferring signals having one or more type of architectures, such as a memory bus, memory controller, a peripheral bus or the like.

Computing device 904 may be implemented in various embodiments. Computing devices may utilize all of the hardware and software components shown, or a subset of the components in embodiments. Levels of integration may vary depending on an embodiment. For example, memory 920 may be divided into many more memories. Furthermore, a computing device 904 may contain multiple instances of a component, such as multiple processors (cores), memories, databases, transmitters, receivers, etc. Computing device 904 may comprise a processor equipped with one or more input/output devices, such as network interfaces, storage interfaces, and the like.

In an embodiment, computing device 904 may be a mainframe computer that accesses a large amount of data related to a cellular network stored in a database. In alternate embodiment, computing device 904 may be embodied as different type of computing device. In an embodiment, types of computing devices include but are not limited to, wearable, personal digital assistant, cellular telephone, tablet, netbook, laptop, desktop, embedded, server, mainframe and/or super (computer).

Memory 920 stores prediction using DV information 901 that includes computer instructions embodied in a computer program. In embodiments, other computer programs such as an operating system, application(s) and a database are stored in memory 920.

In an embodiment, processor 910 may include one or more types of electronic processors having one or more cores. In an embodiment, processor 910 is an integrated circuit processor that executes (or reads) computer instructions that may be included in code and/or computer programs stored on a non-transitory memory to provide at least some of the functions described herein. In an embodiment, processor 910 is a multi-core processor capable of executing multiple threads. In an embodiment, processor 910 is a digital signal processor, baseband circuit, field programmable gate array, digital logic circuit and/or equivalent.

A thread of execution (thread or hyper thread) is a sequence of computer instructions that can be managed independently in one embodiment. A scheduler, which may be included in an operating system, may also manage a thread. A thread may be a component of a process, and multiple threads can exist within one process, executing concurrently (one starting before others finish) and sharing resources such as memory, while different processes do not share these resources. In an embodiment, the threads of a process share its instructions (executable code) and its context (the values of the process's variables at any particular time).

In a single core processor, multithreading is generally implemented by time slicing (as in multitasking), and the single core processor switches between threads. This context switching generally happens often enough that users perceive the threads or tasks as running at the same time. In a multiprocessor or multi-core processor, multiple threads can be executed in parallel (at the same instant), with every processor or core executing a separate thread at least partially concurrently or simultaneously.

Memory 920 may comprise any type of system memory such as static random access memory (SRAM), dynamic random access memory (DRAM), synchronous DRAM (SDRAM), read-only memory (ROM), a combination thereof, or the like. In an embodiment, a memory 920 may include ROM for use at boot-up, and DRAM for program and data storage for use while executing computer instructions. In embodiments, memory 920 is non-transitory or non-volatile integrated circuit memory storage.

Further, memory 920 may comprise any type of memory storage device configured to store data, store computer programs including instructions, and store other information and to make the data, computer programs, and other information accessible via interconnect 970. Memory 920 may comprise, for example, one or more of a solid state drive, hard disk drive, magnetic disk drive, optical disk drive, or the like.

Computing device 904 also includes one or more network interfaces 950 in an embodiment, which may comprise wired links, such as an Ethernet cable or the like, and/or wireless links to access network 903. A network interface 950 allows computing device 904 to communicate with remote computing devices and/or network 903. For example, a network interface 950 may provide wireless communication via one or more transmitters/transmit antennas and one or more receivers/receive antennas.

Computing device 904 communicates or transfers information by way of network 903. In an embodiment, network 903 may be wired or wireless, singly or in combination. In an embodiment, network 903 may be the Internet, a wide area network (WAN) or a local area network (LAN), singly or in combination. In an embodiment, network 903 may include a cellular network including a plurality of cells. Observed or measured data, such as training and testing data, may be obtained from network 903.

In an embodiment, network 903 may include a High Speed Packet Access (HSPA) network, or other suitable wireless systems, such as for example Wireless Local Area Network (WLAN) or Wi-Fi (Institute of Electrical and Electronics Engineers' (IEEE) 802.11x). In an embodiment, computing device 904 uses one or more protocols to transfer information or packets, such as Transmission Control Protocol/Internet Protocol (TCP/IP) packets.

In embodiments, computing device 904 includes input/output (I/O) computer instructions as well as hardware components, such as I/O circuits to receive and output information from and to other computing devices via network 903. In an embodiment, an I/O circuit may include at least a transmitter and receiver circuit.

In embodiments, functions described herein are distributed to other or more computing devices. In embodiments, computing device 904 may act as a server that provides a service while other computing devices act as a client. In an embodiment, computing device 904 and another computing device may act as peers in a peer-to-peer (P2P) relationship.

User interface 960 may include computer instructions as well as hardware components in embodiments. A user interface 960 may include input devices such as a touchscreen, microphone, camera, keyboard, mouse, pointing device and/or position sensors. Similarly, a user interface 960 may include output devices, such as a display, vibrator and/or speaker, to output images, characters, vibrations, speech and/or video as an output. A user interface 960 may also include a natural user interface where a user may speak, touch or gesture to provide input.

FIG. 10 illustrates a software architecture 1000 including prediction using DV information 901 according to embodiments of the present technology. Software architecture 1000 illustrates software components having computer instructions to use DV information to improve learning of a relationship between IVs and a DV. In embodiments, software components illustrated in software architecture 1000 are stored in memory 920 of FIG. 9. In embodiments, software components illustrated in FIG. 9 may be embodied as a computer program, object, function, subroutine, method, software instance, script, a code fragment, stored in an electronic file, singly or in combination. In order to clearly describe the present technology, software components shown in FIG. 9 are described as individual software components. In embodiments, the software components illustrated in FIG. 9, singly or in combination, may be stored (in single or distributed computer-readable storage medium(s)) and/or executed by a single or distributed computing device (processor or multi-core processor) architecture. Functions performed by the various software components described herein are exemplary. In other embodiments, software components identified herein may perform more or less functions. In embodiments, software components may be combined or further separated.

In embodiments, software architecture 1000 includes receive 1001 including training data 1001a and testing data 1001b, cluster 1002 including clusters 1002a and sub-clusters 1002b, learn 1003 including ensemble 1003a, select 1004, model 1005 including models 1005a and models 1005b and output 1006.

Receive 1001 is responsible for, among other functions, receiving and storing data in an electronic file and/or database stored in non-transitory memory. In an embodiment, training data 1001a and testing data 1001b are received and stored by receive 1001.

Cluster 1002 is responsible for, among other functions, clustering or grouping data associated with particular objects, such as clustering cells of a cellular network. In an embodiment, cluster 1002 clusters or groups data from a plurality of cells in a cellular network at least at two levels, such as clusters 1002a and sub-clusters 1002b. In an embodiment, cluster 1002 groups clusters 1002a based on a particular criterion, such as error information, and sub-clusters 1002b based on DV information.

Learn 1003 is responsible for, among other functions, learning a relationship between sets of data. In an embodiment, learn 1003 is a machine learner. In particular, learn 1003 is responsible for building a model associated with two sets of data based on training data in order to output a prediction result. In an embodiment, learn 1003 builds a model between IVs and a DV in a cellular network in order to output a prediction result. In an embodiment, learn 1003 builds one or more models associated with one or more clusters (stored in clusters 1002a) and stores them in models 1005a as well as builds one or more models associated with one or more sub-clusters (stored in sub-clusters 1002b) and stores them in models 1005b.

In an embodiment, a machine learning (or learner) constructs a method that can learn from and make predictions on data. Such methods operate by building a model from an example training set of input observations in order to make data-driven predictions or decisions expressed as outputs, rather than following strictly static program instructions.

In an embodiment, learn 1003 also includes ensemble 1003a that is responsible for, among other functions, providing an ensemble that outputs prediction results based on one or more methods described herein.

Select 1004 is responsible for, among other functions, selecting logic as described herein. In an embodiment, select 1004 includes logic to make appropriate selections, such as selecting the appropriate 1) clusters and/or sub-clusters, 2) models for clusters in models 1005a and/or models for sub-clusters in models 1005b to provide a prediction value and 3) data in training data 1001a and/or testing data 1001b to input to a selected model.

Model 1005 is responsible for, among other functions, to receive and store models to output prediction values, which are built by learn 1003. In an embodiment, model 1005 stores models, such as models for clusters in models 1005a and models for sub-clusters in models 1005b in an electronic file and/or database stored in non-transitory memory.

Output 1006 is responsible for, among other functions, outputting values, such as prediction values from models, to a user interface, such as user interface 960 shown in FIG. 9.

FIG. 11 illustrates a wireless communication network, such as a cellular network 1100 having a plurality of cells 1101-1107, which may be included in network 903. In an embodiment, each cell in a cellular network 1100 includes a base station 1101a to transmit and receive radio frequency (RF) signals to and from a user equipment (UE) 1101b. In an embodiment, a base station 1101a includes at least one antenna to transmit and receive RF signals as well as electronics, such as a computing device, to transfer information to and from a base station 1101a. In embodiment, a large number of UEs are transmitting and receiving RF signals from respective base stations in respective cells in a cellular network 1100. In embodiments, base stations are coupled to a switching computing device and/or central computing device via wired and/or wireless electronic connections. In order to clearly describe the technology, a single base station 1101a and UE 1101b is illustrated in cell 1101 of FIG. 11.

In an embodiment, UE 1101b is a computing device embodied as a cellular telephone. In other embodiments, UE 1101b may be other types of computing devices that transmit and receive RF signals in a cellular network 1100. UE 1101b may include a processor, memory, transceiver and user interface.

As described herein, cellular network 1100 may have a plurality of cells 1101-1107, which may be grouped or clustered/sub-clusters. For example, cells 1101-1104 may form a first cluster and cells 1105-1107 may form a second cluster. The first cluster may further grouped into a first sub-cluster including cells 1101-1102 and a second sub-cluster including cells 1103-104.

Advantages of the present technology may include, but are not limited to, more accurate predictions of KPIs and/or KQIs that may be requested by operators of cellular networks. More accurate predictions may aid in analyzing and/or determining network expansion, network diagnosis and/or root cause analysis. A more accurate KPI prediction may be important for service provisioning and KQI, from a revenue perspective and user equipment's quality of experience perspective.

The flowcharts and block diagrams in the figures illustrate the architecture, functionality, and operation of possible implementations of a device, apparatus, system, computer-readable medium and method according to various aspects of the present disclosure. In this regard, each block (or arrow) in the flowcharts or block diagrams may represent operations of a system component, software component or hardware component for implementing the specified logical function(s). It should also be noted that, in some alternative implementations, the functions noted in the block may occur out of the order noted in the figures. For example, two blocks (or arrows) shown in succession may, in fact, be executed substantially concurrently, or the blocks (or arrows) may sometimes be executed in the reverse order, depending upon the functionality involved. It will also be noted that each block (or arrow) of the block diagrams and/or flowchart illustration, and combinations of blocks (or arrows) in the block diagram and/or flowchart illustration, can be implemented by special purpose hardware-based systems that perform the specified functions or acts, or combinations of special purpose hardware and computer instructions.

It will be understood that each block (or arrow) of the flowchart illustrations and/or block diagrams, and combinations of blocks (or arrows) in the flowchart illustrations and/or block diagrams, may be implemented by non-transitory computer instructions. These computer instructions may be provided to and executed (or read) by a processor of a general purpose computer (or computing device), special purpose computer, or other programmable data processing apparatus to produce a machine, such that the instructions executed via the processor, create a mechanism for implementing the functions/acts specified in the flowcharts and/or block diagrams.

As described herein, aspects of the present disclosure may take the form of at least a system, device having one or more processors executing instructions stored in non-transitory memory, a computer-implemented method, and/or non-transitory computer-readable storage medium storing computer instructions.

Non-transitory computer-readable media includes all types of computer-readable media, including magnetic storage media, optical storage media, and solid state storage media and specifically excludes signals. It should be understood that software including computer instructions can be installed in and sold with a computing device having computer-readable storage media. Alternatively, software can be obtained and loaded into a computing device, including obtaining the software via a disc medium or from any manner of network or distribution system, including, for example, from a server owned by a software creator or from a server not owned but used by the software creator. The software can be stored on a server for distribution over the Internet, for example.

More specific examples of the computer-readable medium include the following: a portable computer diskette, a hard disk, a random access memory (RAM), ROM, an erasable programmable read-only memory (EPROM or Flash memory), an appropriate optical fiber with a repeater, a portable compact disc read-only memory (CD-ROM), an optical storage device, a magnetic storage device, or any suitable combination thereof.

Non-transitory computer instructions used in embodiments of the present technology may be written in any combination of one or more programming languages. The programming languages may include an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The computer instructions may be executed entirely on the user's computer (or computing device), partly on the user's computer, as a stand-alone software package, partly on the user's computer and partly on a remote computer, or entirely on the remote computer or server. In the latter scenario, the remote computer may be connected to the user's computer through any type of network, or the connection may be made to an external computer (for example, through the Internet using an Internet Service Provider) or in a cloud computing environment or offered as a service such as a Software as a Service (SaaS).

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the detailed description of the present subject matter, numerous specific details are set forth in order to provide a thorough understanding of the present subject matter. However, it will be clear to those of ordinary skill in the art that the present subject matter may be practiced without such specific details.

Although the subject matter has been described in language specific to structural features and/or methodological steps, it is to be understood that the subject matter defined in the appended claims is not necessarily limited to the specific features or steps (acts) described above. Rather, the specific features and steps described above are disclosed as example forms of implementing the claims.

What is claimed is:

1. A device comprising:
a non-transitory memory storing instructions; and
one or more processors in communication with the non-transitory memory, wherein the one or more processors execute the instructions to:
receive training data that represent dependent variable information from a plurality of cells in a cellular network,
select one or more clusters of cells from the plurality of cells,
select one or more sub-clusters of cells from the one or more clusters of cells based on the dependent variable information;
determine one or more models corresponding the one or more sub-clusters of cells based on a relationship between the dependent variable information and independent variable information;
receive testing data from the plurality of cells in the cellular network; and
output a prediction value from the one or more models in response to the testing data.

2. The device of claim 1, wherein the dependent variable information includes a time series of key quality indicators (KQIs) in a first cell of the plurality of cells.

3. The device of claim 2, wherein the key quality indicators includes at least one of:
packet loss, delay, mobile user average throughput, cell level total throughput, mobile user average throughput in the first cell of the plurality of cells or cell level total throughput of the plurality of cells.

4. The device of claim 1, wherein the independent variable information includes a time series of key performance indicators (KPIs) in a first cell of the plurality of cells.

5. The device of claim 4, wherein the key performance indicators includes at least one of: total traffic amount in the first cell, total number of bits transmitted in the first cell, total number of users in the first cell, uplink interference level, handover success rate or physical channel resource usage rate.

6. The device of claim 1, wherein the one or more processors execute instructions to
select a first model from the one or more models using the dependent variable information; and
output a prediction value from the first model in response to the testing data.

7. A computer-implemented method, comprising:
receiving training data that represent dependent variable information from a plurality of cells in a cellular network,
selecting one or more clusters of cells from the plurality of cells,
selecting one or more sub-clusters of cells from the one or more clusters of cells based on the dependent variable information;
determining one or more models corresponding the one or more sub-clusters of cells based on a relationship between the dependent variable information and independent variable information;
receiving testing data from the plurality of cells in the cellular network; and
outputting a prediction value from the one or more models in response to the testing data.

8. The computer-implemented method of claim 7, wherein the dependent variable information includes a time series of key quality indicators (KQIs) in a first cell of the plurality of cells.

9. The computer-implemented method of claim 8, wherein the key quality indicators includes at least one of: packet loss, delay, mobile user average throughput, cell level total throughput, mobile user average throughput in the first cell of the plurality of cells or cell level total throughput of the plurality of cells.

10. The computer-implemented method of claim 7, wherein the independent variable information includes a time series of key performance indicators (KPIs) in a first cell of the plurality of cells.

11. The computer-implemented method of claim 10, wherein the key performance indicators includes at least one of: total traffic amount in the first cell, total number of bits transmitted in the first cell, total number of users in the first cell, uplink interference level, handover success rate or physical channel resource usage rate.

12. The computer-implemented method of claim 7, comprising:
selecting a first model from the one or more models using the dependent variable information; and
outputting a prediction value from the first model in response to the testing data.

13. A device comprising:
a non-transitory memory storing instructions; and
one or more processors in communication with the non-transitory memory, wherein the one or more processors execute the instructions to:
receive training data that represent dependent variable information from a plurality of cells in a cellular network;
select one or more clusters of cells from the plurality of cells;
determine one or more models based on a relationship between dependent variable information and independent variable information;
receive testing data from the plurality of cells in the cellular network;
select a first model from the one or more models based on the dependent variable information; and
output a prediction value to analyze the cellular network from the first model in response to the testing data.

14. The device of claim 13, wherein the dependent variable information includes a time series of key quality indicators (KQIs) and the independent variable information includes a time series of key performance indicators (KPIs) in a first cell of the plurality of cells.

15. The device of claim 14, wherein the key quality indicators includes at least one of: packet loss, delay, mobile user average throughput, cell level total throughput, mobile user average throughput in the first cell of the plurality of cells or cell level total throughput of the plurality of cells.

16. The device of claim 14 wherein the key performance indicators includes at least one of: total traffic amount, total number of bits transmitted, total number of users, uplink interference level, handover success rate or physical channel resource usage rate.

17. A computer-implemented method, comprising:
receiving, with one or more processors, training data that represent dependent variable information from a plurality of cells in a cellular network;
selecting, with the one or more processors, one or more clusters of cells from the plurality of cells;
determining, with the one or more processors, one or more models based on a relationship between dependent variable information and independent variable information;
receiving, with the one or more processors, testing data from the plurality of cells in the cellular network;
selecting, with the one or more processors, a first model from the one or more models based on the dependent variable information; and
outputting, with the one or more processors, a prediction value to analyze the cellular network from the first model in response to the testing data.

18. The computer-implemented method of claim 17, wherein the dependent variable information includes a time series of key quality indicators (KQIs) and the independent variable information includes a time series of key performance indicators (KPIs) in a first cell of the plurality of cells.

19. The computer-implemented method of claim 18, wherein the key quality indicators includes at least one of: packet loss, delay, mobile user average throughput, cell level total throughput, mobile user average throughput in the first cell of the plurality of cells or cell level total throughput of the plurality of cells.

20. The computer-implemented method of claim 18 wherein the key performance indicators includes at least one of: total traffic amount, total number of bits transmitted, total number of users, uplink interference level, handover success rate or physical channel resource usage rate.
